(19) United States
(12) Patent Application Publication
(10) Pub. No.: US 2022/0365810 A1
(43) Pub. Date: Nov. 17, 2022

(54) THREAD SIGNAL OPERATING METHOD AND SYSTEM OF EMBEDDED REAL TIME OPERATING SYSTEM

(71) Applicant: SOOCHOW UNIVERSITY, Suzhou (CN)

(72) Inventors: Yihuai WANG, Suzhou (CN); Yingqiu DONG, Suzhou (CN); Changyong LIU, Suzhou (CN); Chuanghua CAI, Suzhou (CN); Jian ZHANG, Suzhou (CN)

(21) Appl. No.: 17/761,277

(22) PCT Filed: Dec. 18, 2020
(86) PCT No.: PCT/CN2020/137578

§ 371 Date: Mar. 17, 2022

(30) Foreign Application Priority Data
Apr. 23, 2020 (CN) 202010328823.2

(51) Int. Cl. G06F 9/48

(52) U.S. Cl. CPC G06F 9/4831; G06F 9/4881

(57) ABSTRACT

The present invention provides a thread signal operating method and system of an embedded real-time operating system, which relates to the technical field of communications. The system includes a main control module and a PC. A core of the main control module is an MCU chip and includes a serial port and a USB port. The serial port is used as a default communication device to communicate with the external. The USB port is connected to a USB port of the PC. The main control module further includes an actual thread signal waiting module, an actual thread signal setting module, a system service call interrupt module, and a suspendable system call interrupt module. Multi-threaded signal processing according to task allocation rules can reduce overhead caused by interactions, improve processing efficiency, reduce power consumption, and reduce hardware module superposition.

### TECHNICAL FIELD

The present invention relates to the technical field of communications, and in particular to a thread signal operating method and system of an embedded real-time operating system.

### BACKGROUND

Thread signals can be applied in many scenarios For example, a plurality of tasks read and write a shared area, in which task A may send a signal to task B after a write operation is completed, and upon receiving this signal, task B may perform a read operation; downstream tasks need to wait for the completion of upstream tasks; when a thread crosses the boundary, or attempts to write a read-only memory area (such as a program body area), or executes a privileged instruction and various other hardware errors; a system call that does not exist is executed; and the thread exits, or a child thread terminates, and the like, which can all be achieved through signals.

With the continuous development of the communication field, various thread signal processing structures emerge in endlessly. In this case, most of thread signal operations are realized through superposition of hardware modules, which leads to a continuous expansion of chip area and power consumption, and is very inflexible, the upgrade cost is very high, and its implementation efficiency is relatively low, resulting in higher processor frequency requirements and higher power consumption. Therefore, the existing simple thread signal processing structure cannot effectively meet the high-efficiency and flexible processing requirements.

### SUMMARY OF THE INVENTION

An object of the present invention is to provide a thread signal operating method and system of an embedded real-time operating system, in order to solve the problem in the prior art that thread signal operations are realized through superposition of hardware modules, which leads to a continuous expansion of chip area and power consumption, and is very inflexible, the upgrade cost is very high, and its implementation efficiency is relatively low, resulting in higher processor frequency requirements and higher power consumption. The technical effects that can be produced by a preferred technical solution among the technical solutions according to the present invention are described in detail below.

In order to achieve the above object, the present invention provides the following technical solutions.

The thread signal operating system of an embedded real-time operating system according to the present invention, including a main control module and a PC, wherein a core of the main control module is an MCU chip and includes a serial port and a USB port, the serial port is used as a default communication device to communicate with the external, and the USB port is connected to a USB port of the PC, and the main control module further includes an actual thread signal waiting module, an actual thread signal setting module, a system service call interrupt module, and a suspendable system call interrupt module.

Optionally, the actual thread signal waiting module is configured to add a waiting mark to a first task thread or a second task thread running, suspend the running of the first task thread or the second task thread and place the same in a waiting queue.

Optionally, the suspendable system call interrupt module is configured to fetch data from an interrupt queue; execute a corresponding processing program module based on the type of data fetched; and fetch a thread with the highest priority from a ready queue.

Optionally, the core MCU chip of the main control module is provided with a register set including a general register, a stack pointer register, a connection register, a program count register, and a special function register.

Optionally, the special function register includes a program module status word register set configured to save some status information when a program module is running; an interrupt mask register configured to set a mask interrupt; and a control register configured to set a current stack pointer and a privileged access mode.

A thread signal operating method of an embedded real-time operating system, based on the above thread signal operating system includes the following steps:

step 1: macro-defining a thread signal, including a first task thread signal, a second task thread signal and a third task thread signal;

step 2: setting a waiting thread signal for a first task, wherein the thread signal is 1_SIGNAL, and in this case, the first task enters a delay queue, and enters a ready queue until a serial port sends the thread signal 1_SIGNAL, and is scheduled by the system to complete the execution of subsequent modules; and setting a waiting thread signal for a second task, wherein the thread signal is 2_SIGNAL, and in this case, the second task enters the delay queue, and enters the ready queue until a third task sends the thread signal 2_SIGNAL, and is scheduled by the system to complete the execution of subsequent modules; and

step 3: sending the thread signal

setting the thread signal in an interrupt: setting a serial port receiving interrupt service routine to send the thread signal 1_SIGNAL to the first task, wherein a value of the thread signal sent is the same as that of the waiting thread signal set in step 2; and

setting the thread signal in a user thread: setting the third task to send the thread signal 2_SIGNAL to the second task, wherein a value of the thread signal sent is the same as that of the waiting thread signal set in step 2.

Optionally, in step 2, when the waiting thread signal is set for the first task or the second task and scheduled by the system to complete the execution of subsequent modules, its scheduling module includes the actual thread signal waiting module to complete the scheduling of the thread.

Optionally, in step 2, when the third task sends the thread signal 2_SIGNAL to the second task thread and the subsequent modules are executed after the second task thread receives the thread signal, the call of its module includes the actual call of the actual thread signal setting module to complete the scheduling of the thread.

Optionally, in step 3, when the thread signal is set in the interrupt, it is completed by the suspendable system call interrupt module.

Optionally, in step 3, when the thread signal is set in the user task, the system service calls the system service call interrupt module to complete.

The thread signal operating method and system of an embedded real-time operating system according to the present invention bring about the following beneficial effects.

In the present invention, a thread signal 1_SIGNAL is sent by a serial port, a first task enters a ready queue and is scheduled by the system to complete the execution of subsequent modules; a third task sends a thread signal 2_SIGNAL, and a second task enters the ready queue and is scheduled by the system to complete the execution of subsequent modules; and an actual thread signal waiting module adds a waiting mark to the first task thread or the second task thread running, suspends the running of the first task thread or the second task thread and places the same in a waiting queue. In this way, multi-threaded signal processing can be performed according to task allocation rules to reduce overhead caused by interactions, improve processing efficiency, reduce power consumption, and reduce hardware module superposition.

### BRIEF DESCRIPTION OF THE DRAWINGS

In order to describe the technical solutions in the embodiments of the present invention or the prior art more clearly, drawings to be used in the description of the embodiments or the prior art will be briefly introduced hereinafter. Obviously, the drawings described hereinafter are only some embodiments of the present invention. For those of ordinary skill in the art, other drawings may be obtained based on these drawings without creative work.

FIG. 1 is a schematic diagram of the architecture of The thread signal operating system of an embedded real-time operating system according to the present invention;

FIG. 2 is a scheduling timing diagram of threads with the same priority based on thread signals according to the present invention;

FIG. 3 is an execution flow chart of an actual thread signal waiting module according to the present invention; and

FIG. 4 is an execution flow chart of an actual thread signal setting module according to the present invention.

### DETAILED DESCRIPTION

In order to make the objectives, technical solutions and advantages of the present invention clearer, the technical solutions of the present invention will be described in detail below. Obviously, the embodiments described are only a part of the embodiments of the present invention, rather than all the embodiments. Based on the embodiments of the present invention, all other implementations obtained by those of ordinary skill in the art without creative work shall fall within the protection scope of the present invention.

### Embodiment 1

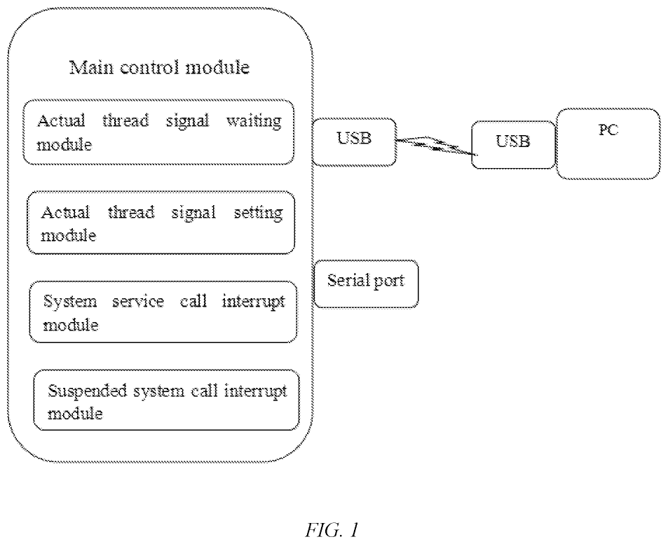

As shown in FIG. 1, a thread signal operating system of an embedded real-time operating system includes a main control module and a PC. A core of the main control module is an MCU chip and includes a serial port and a USB port. The serial port is used as a default communication device to communicate with the external. The USB port is connected to a USB port of the PC. The main control module further includes an actual thread signal waiting module, an actual thread signal setting module, a system service call interrupt module, and a suspendable system call interrupt module. The actual thread signal waiting module is configured to add a waiting mark to a first task thread or a second task thread running, suspend the running of the first task thread or the second task thread and place the same in a waiting queue. The suspendable system call interrupt module is configured to fetch data from an interrupt queue; execute a corresponding processing program module based on the type of data fetched; and fetch a thread with the highest priority from a ready queue. The core MCU chip of the main control module is provided with a register set including a general register, a stack pointer register, a connection register, a program count register, and a special function register. The special function register includes: a program module status word register set configured to save some status information when a program module is running; an interrupt mask register configured to set a mask interrupt; and a control register configured to set a current stack pointer and a privileged access mode.

### Embodiment 2

On the basis of embodiment 1, as a further preferred solution, a thread signal operating method of an embedded real-time operating system based on the above thread signal operating system includes the following steps:

step 1: macro-defining a thread signal, including a first task thread signal, a second task thread signal and a third task thread signal;

step 2: setting a waiting thread signal for a first task, wherein the thread signal is 1_SIGNAL, and in this case, the first task enters a delay queue, and enters a ready queue until a serial port sends the thread signal 1_SIGNAL, and is scheduled by the system to complete the execution of subsequent modules; and setting a waiting thread signal for a second task, wherein the thread signal is 2_SIGNAL, and in this case, the second task enters the delay queue, and enters the ready queue until a third task sends the thread signal 2_SIGNAL, and is scheduled by the system to complete the execution of subsequent modules; and

wherein when the waiting thread signal is set for the first task or the second task and scheduled by the system to complete the execution of subsequent modules, its scheduling module comprises the actual thread signal waiting module to complete the scheduling of the thread; and when the third task sends the thread signal 2_SIGNAL to the second task thread and the subsequent modules are executed after the second task thread receives the thread signal, the call of its module comprises the actual call of the actual thread signal setting module to complete the scheduling of the thread.

step 3: sending the thread signal

setting the thread signal in an interrupt: setting a serial port receiving interrupt service routine to send the thread signal 1_SIGNAL to the first task, wherein a value of the thread signal sent is the same as that of the waiting thread signal set in step 2; and

setting the thread signal in a user thread: setting the third task to send the thread signal 2_SIGNAL to the second task, wherein a value of the thread signal sent is the same as that of the waiting thread signal set in step 2.

wherein, when the thread signal is set in the interrupt, it is completed by the suspendable system call interrupt module; and when the thread signal is set in the user task, the system service calls the system service call interrupt module to complete.

### Embodiment 3

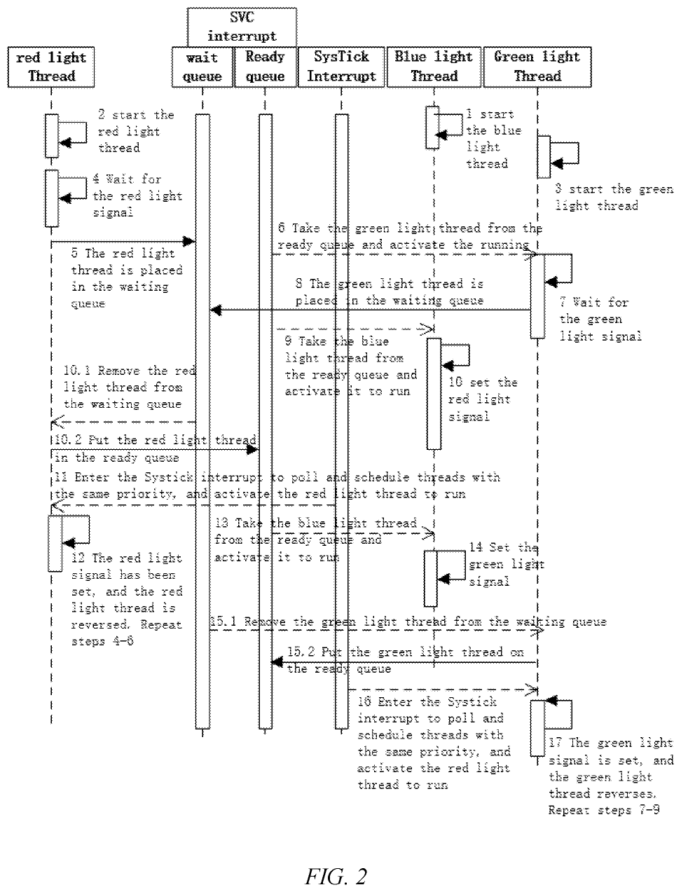

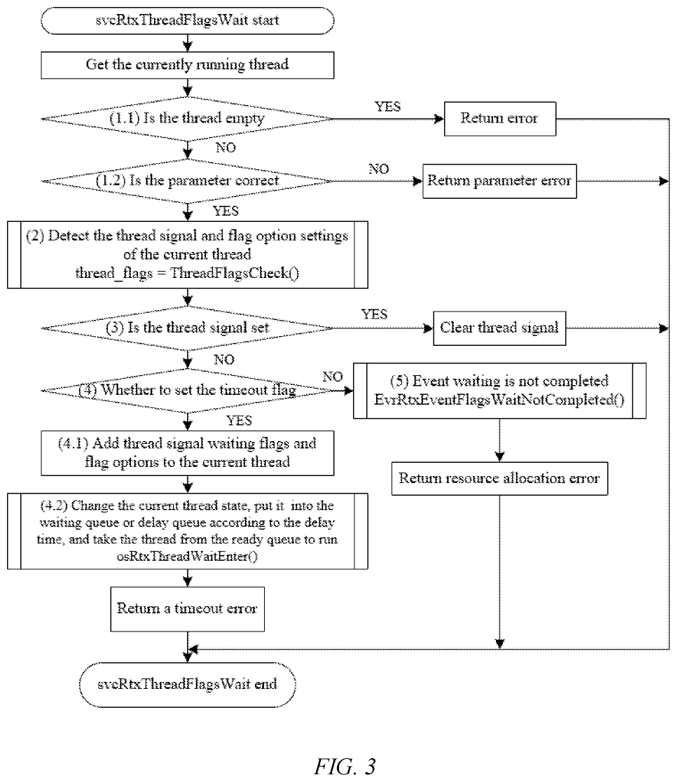

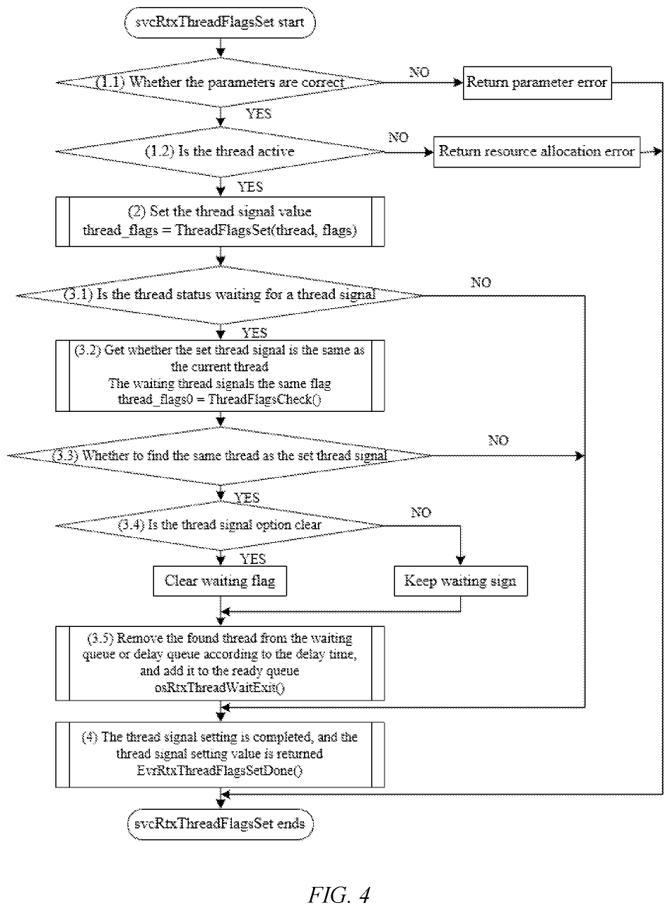

On the basis of embodiments 1 and 2, as a further preferred solution: as shown in FIGS. 2 to 4, the MCU chip is a KL36 board kit. The MCU of this kit is Kinetis MKL36Z64VLH4 with ARM Cortex-M0+ core. The chip is a 64-pin LQFP package, 64 KB Flash, including a SysTick timer, a GPIO, a serial port, an A/D, a D/A, an I2C, an SPI, a CAN, a USB, as well as test hardware and an MUC evaluation board. The serial port is connected to the MUC evaluation board. The test hardware is connected to the MUC evaluation board and controlled by the main control module. The serial port is used as a default communication device to communicate with the external. The “USB port” of the “USB-MicroUSB serial cable” is connected to the USB port of the PC. The MicroUSB end of the serial cable is connected to the MicroUSB port on the AHL-IOT-GEC evaluation board (corresponding to UART_2, and PTE16 and PTE17 are used as transceiver pins of the serial port). The test hardware is three-color light hardware, which is connected to S1 of the AHL-IOT-GEC evaluation board and controlled by the PTAS, PTA12 and PTA13 pins of the KL36 chip. The above hardware connection is taken as a sample project to realize the scheduling of three tasks. A blue light (a second task) waits for a green light (a third task) to send a thread signal (0x11 in this sample). A red light (a first task) flashes every 3 seconds by waiting for a thread signal (serial port thread signal, which is 0x22 in this sample).

1) Execution Process Analysis of Red Light

In this sample, the execution process of the red light needs to wait for the serial port to send the thread signal (0x22), while the execution process of the blue light needs to wait for the green light to send the thread signal (0x11). When a red light thread enters the waiting queue, the subsequent modules (flashing once every 3 seconds) will be not executed until a thread signal RED_SIGNAL sent from the serial port is received. The calling sequence of this module is: signal_wait( )→osThreadFlagsWait( )→_sycThreadFlagsWait( )→trigger system service call interrupt→actual thread signal waiting module. The main function of the actual thread signal waiting module is to add a waiting mark to the running thread (red light thread in this sample), suspend the running of the red light thread and place the same in the waiting queue.

2) Execution Process Analysis of Blue Light

When a blue light thread enters the waiting queue, the subsequent statement (flashing once every 2 seconds) will not be executed until a thread signal BLUE__SIGNAL sent from the green light is received. The calling sequence of this statement is: signal_wait( )→osThreadFlagsWait( )→_sycThreadFlagsWait( )→trigger system service call interrupt SVC Handler→actual thread signal waiting module. The main function of the actual thread signal waiting module is to add a waiting mark to the running thread (blue light thread in this sample), suspend the running of the blue light thread and place the same in the waiting queue.

When a green light task executes the statement of thd_bluelight.signal_set(BLUE_SIGNAL), i.e., sending the thread signal BLUE_SIGNAL to the blue light thread, the blue light thread will not execute subsequent statements until this thread signal is received. The calling sequence of this statement is: signal_set( )→osThreadFlagsSet( )→_sycThreadFlagsSet ( )→trigger system service call interrupt SVC_Handler→call the actual thread signal setting module to complete the scheduling of the thread.

It can be seen that the various tasks cooperate with each other. The core of the operating system is responsible for allocating a small part of CPU resources for all tasks, and then the functions of each task can be executed correctly.

It should be noted that the main function of the actual thread signal waiting module (i.e., svcRtxThreadFlagsWait) is to: (1) determine whether the thread and parameters are correct; (2) add a thread signal waiting flag and a flag option to the current thread; (3) change a status of a thread waiting for an event bit and place the same in the waiting queue, and then fetch the thread from the ready queue for running; and (4) return various status code values of the thread. The main function of the actual thread signal setting module (i.e., svcRtxThreadFlagsSet): (1) determine whether an event status and parameters are correct; (2) set an event bit of an event word; (3) in a thread list, look up for a thread with an event bit for which the thread is waiting the same as the event bit set, and after finding the thread, remove the thread from the delay queue and add the same to the ready queue; and (4) fetch a thread with the highest priority from the ready queue. The system service call provides an entrance to the system service. The system service call interrupt service program is a very important program in this sample program. The main function of the SVC_Handler module is to: in the system service call interrupt service program, obtain a return address value in a stack based on a PSP value, and extract an immediate number from machine codes of an system service call instruction as a call number. In mbedOS, the calling number is 0 for system services, and others are user-defined services. In the system service call interrupt service program, it is also necessary to decide whether to perform context switching and thread switching based on thread running information in the current OS real-time status osRtxInfo.

The thread scheduling process is described hereinafter.

1) Thread Starts

In this sample, the chip is powered on and finally transferred to execution of a main thread. In this sample, three threads, i.e., red light, blue light, and green light, are created and started sequentially, and then blocked. mbedOS starts thread scheduling, and fetches a thread with the highest priority (i.e., the blue light thread) from the ready queue to activate and run.

2) Red Light Thread Waits for Red Light Signal

The SysTick timer interrupt will be interrupted every 1 ms, and round-robin schedule the thread with each time slice (5 ms) as a cycle. The red light thread is activated to run. The red light thread waits for the red light signal RED_SIGNAL. During the call, the red light thread will be placed in the waiting queue, and a thread with the highest priority (which is the green light thread in this case) will be fetched from the ready queue to activate and run.

3) Green Light Thread Waits for Green Light Signal

The green light thread waits for the green light signal GREEN SIGNAL. During the call, the green light thread will be placed in the waiting queue, and a thread with the highest priority (which is the blue light thread in this case) will be fetched from the ready queue to activate and run.

4) Blue Light Thread Sets Red Light Signal

The blue light thread sets the red light signal. The red light thread is removed from the waiting queue, and placed in the ready queue. Because the thread priority is the same, the red light thread will not preempt the currently running blue light thread, but will be activated to run through round-robin scheduling in the SysTick timer interrupt.

5) Round-Robin Scheduling Activates Red Light Thread

The SysTick timer interrupt will be interrupted every 1 ms and round-robin schedule the thread with each time slice (5 ms) as a cycle. The red light thread will be activated to run.

6) Red Light Thread Waits Until the Red Light Signal

The red light thread waits until the red light signal to switch the red light on and off. Then a new round of thread signal waiting (repeating steps 4)-6)) starts. The blue light thread is activated to run.

7) Blue Light Thread Sets Green Light Signal

The blue light thread sets the green light signal. The green light thread removed from the waiting queue, and placed in the ready queue. Because the thread priority is the same, the green light thread will not preempt the currently running blue light thread, but will be activated to run through round-robin scheduling in the SysTick timer interrupt.

8) Round-Robin Scheduling Activates Green Light Thread

The SysTick timer interrupt will be interrupted every 1 ms and round-robin schedule the thread with each time slice (5 ms) as a cycle. The green light thread will be activated to run.

9) Green Light Thread Waits Until Green Light Signal

The green light thread waits until the green light signal to switch the green light on and off. Then a new round of thread signal waiting (repeating steps 7)-9)) starts. The blue light thread is activated to run.

Description: in this sample, an empty loop statement is used instead of a delay function for delay, mainly to simplify the thread scheduling process. At the same time, because the thread priority is the same, the SysTick timer interrupt will be interrupted every 1 ms and round-robin schedule the thread every time a time slice (5 ms) arrives.

The above are merely specific embodiments of the present invention. However, the protection scope of the present invention is not limited to this. Any person skilled in the art can easily conceive of changes or substitutions within the technical scope disclosed by the present invention, which should be covered by the protection scope of the present invention. Therefore, the protection scope of the present invention should be subject to the protection scope of the claims.

1. A thread signal operating system of an embedded real-time operating system, comprising a main control module and a PC, wherein a core of the main control module is an MCU chip and comprises a serial port and a USB port, the serial port is used as a default communication device to communicate with the external, and the USB port is connected to a USB port of the PC, and the main control module further comprises an actual thread signal waiting module, an actual thread signal setting module, a system service call interrupt module, and a suspendable system call interrupt module,
wherein the actual thread signal waiting module is configured to add a waiting mark to a first task thread or a second task thread running, suspend the running of the first task thread or the second task thread and place the same in a waiting queue.

2. (canceled)

3. The thread signal operating system of an embedded real-time operating system according to claim 1, wherein the suspendable system call interrupt module is configured to fetch data from an interrupt queue; execute a corresponding processing program module based on the type of data fetched; and fetch a thread with the highest priority from a ready queue.

4. The thread signal operating system of an embedded real-time operating system according to claim 3, wherein the core MCU chip of the main control module is provided with a register set comprising a general register, a stack pointer register, a connection register, a program count register, and a special function register.

5. The thread signal operating system of an embedded real-time operating system according to claim 4, wherein the special function register comprises a program module status word register set configured to save some status information when a program module is running; an interrupt mask register configured to set a mask interrupt; and a control register configured to set a current stack pointer and a privileged access mode.

6. A thread signal operating method of an embedded real-time operating system based on the thread signal operating system of claim 1, comprising:
step 1: macro-defining a thread signal, comprising a first task thread signal, a second task thread signal and a third task thread signal;
step 2: setting a waiting thread signal for a first task, wherein the thread signal is 1_SIGNAL, and in this case, the first task enters a delay queue, and enters a ready queue until the serial port sends the thread signal 1_SIGNAL, and is scheduled by the system to complete the execution of subsequent modules; and setting a waiting thread signal for a second task, wherein the thread signal is 2_SIGNAL, and at this time, the second task enters the delay queue, and enters the ready queue until a third task sends the thread signal 2_SIGNAL, and is scheduled by the system to complete the execution of subsequent modules; and
step 3: sending the thread signal
setting the thread signal in an interrupt: setting a serial port receiving interrupt service routine to send the thread signal 1_SIGNAL to the first task, wherein a value of the thread signal sent is the same as that of the waiting thread signal set in step 2; and
setting the thread signal in a user thread: setting the third task to send the thread signal 2_SIGNAL to the second task, wherein a value of the thread signal sent is the same as that of the waiting thread signal set in step 2.

7. The thread signal operating method of an embedded real-time operating system according to claim 6, wherein, in step 2, when the waiting thread signal is set for the first task or the second task and scheduled by the system to complete the execution of subsequent modules, its scheduling module comprises the actual thread signal waiting module to complete the scheduling of the thread.

8. The thread signal operating method of an embedded real-time operating system according to claim 6, wherein, in step 2, when the third task sends the thread signal 2_SIGNAL to the second task thread and the subsequent modules are executed after the second task thread receives the thread signal, the call of its module comprises the actual call of the actual thread signal setting module to complete the scheduling of the thread.

9. The thread signal operating method of an embedded real-time operating system according to claim 6, wherein, in step 3, when the thread signal is set in the interrupt, it is completed by the suspendable system call interrupt module.

10. The thread signal operating method of an embedded real-time operating system according to claim 6, wherein, in step 3, when the thread signal is set in the user task, the system service calls the system service call interrupt module to complete.
